(19) United States
(12) Patent Application Publication
(10) Pub. No.: US 2011/0281140 A1
(43) Pub. Date: Nov. 17, 2011

(54) BATTERY PACK

(76) Inventors: Seong-Joon Lee, Yongin-si (KR); Myung-Jun Lee, Yongin-si (KR)

(21) Appl. No.: 12/848,059

(22) Filed: Jul. 30, 2010

Related U.S. Application Data
(60) Provisional application No. 61/345,036, filed on May 14, 2010.

(51) Int. Cl. H01M 10/42

(52) U.S. Cl. 429/7

(57) ABSTRACT

A battery pack including a rechargeable battery cell; an electrode tap that is partially exposed from an outside of the rechargeable battery cell; a protection circuit module (PCM) comprising a protection circuit with respect to the rechargeable battery cell; and a connection block disposed on the PCM, for electrically connecting the electrode tap to the PCM.

### BACKGROUND

1. Field

One or more embodiments of the present invention relate to a battery pack capable of reliably maintaining an electrical connection between an electrode tap and a protection circuit module (PCM) of a battery cell without damaging the PCM.

2. Description of the Related Art

A protection circuit is mounted in a battery in order to prevent the battery from being excessively charged or discharged. The protection circuit of the battery is generally embodied as a hard printed circuit board (PCB). The hard PCB embodying the protection circuit is connected to an external control circuit module or a terminal of a battery module using wires.

Wires or terminals are connected to the hard PCB using a soldering method. However, heat generated during a soldering operation causes thermal damage to a circuit device disposed on the hard PCB. Further, it is difficult to connect the hard PCB and wires using the soldering method, which causes many defective products.

### SUMMARY OF THE INVENTION

One or more embodiments of the present invention include a battery pack maximizing use of an inner space of a protection circuit module (PCM) and having an electrical connection easily formed between an electrode tap and the PCM.

According to one or more embodiments of the present invention, a battery pack includes a rechargeable battery cell; an electrode tap that is partially exposed from an outside of the rechargeable battery cell; a protection circuit module (PCM) comprising a protection circuit with respect to the rechargeable battery cell; and a connection block disposed on the PCM, for electrically connecting the electrode tap to the PCM.

The battery pack may further include: a connection terminal having one surface contacting the connection block and another surface contacting the electrode tap.

The connection terminal may include: a first terminal portion for contacting one side surface of the connection block; and a second terminal portion extending from the first terminal portion, disposed to form a predetermined angle with the first terminal portion, and contacting the electrode tap.

A thickness of the first terminal portion may be different from a thickness of the second terminal portion.

The first terminal portion and the second terminal portion may be disposed to be perpendicular to each other.

The second terminal portion may be bent to wrap around the electrode tap and contact the electrode tap.

The connection terminal and the connection blocks may be integrally formed to each other.

At least one connection block and the connection terminal may be formed of a nickel material.

The electrode tap may be electrically connected to the PCM by welding the electrode tap and the connection block to each other.

The welding may be laser welding.

Thicknesses of the connection block may be from about 0.3 mm to about 1.2 mm.

The connection block may be partially buried in the PCM.

The rechargeable battery cell may be a polymer cell.

### EFFECT OF THE INVENTION

The embodiments of the present invention use a plurality of connection blocks, or a plurality of connection blocks and an electrode terminal to enable a welding operation of connecting an electrode tap and a protection circuit module (PCM) to be easily performed. Furthermore, thermal damage to other elements, such as a substrate, a protection circuit, or a device may be reduced.

Meanwhile, connection blocks are fixed to one side surface of the substrate, and a connection terminal is formed via the connection blocks to electrically connect the electrode tap and the PCM to each other. Thus, there is no damage to the inner space of the PCM, That is, the inner space of the PCM remains unchanged, which increases a utility of space in such a way that other parts may be mounted in the battery pack, and enables minimization of the battery pack.

### BRIEF DESCRIPTION OF THE DRAWINGS

FIG. 1 is a schematic perspective view of an assembling structure of a battery pack according to an embodiment of the present invention;

FIG. 2 is a schematic exploded perspective view of an assembling state of a protection circuit module 300 (PCM) and a plurality of connection blocks 340 of FIG. 1 according to an embodiment of the present invention;

FIG. 3 is a schematic exploded perspective view of an assembling state of the PCM 300 and the plurality of connection blocks 340 of FIG. 1 according to another embodiment of the present invention;

FIG. 4 is a perspective view of the battery pack assembled with the PCM 300 of FIG. 1;

FIG. 5 is a cross-sectional view of the battery pack and the PCM of FIG. 4 taken along a line V-V;

FIG. 6 is a schematic perspective view of an assembling structure of a battery pack according to another embodiment of the present invention;

FIG. 7 is a schematic exploded perspective view of an assembling state of a PCM 600, a plurality of connection blocks 640, and a connection terminal 660 of FIG. 6 according to an embodiment of the present invention;

FIG. 8 is a perspective view of the battery pack assembled with the PCM 600 of FIG. 7;

FIG. 9 is a cross-sectional view of the battery pack and PCM of FIG. 8 taken along a line IX-IX;

FIGS. 10 through 12 are cross-sectional views for explaining a process of assembling the battery pack of FIG. 9; and

FIG. 13 is a cross-sectional view of the battery pack of FIG. 9 according to another embodiment of the present invention.

### DETAILED DESCRIPTION FOR PRACTICING

Hereinafter, the inventive concept will be described more fully with reference to the accompanying drawings, in which exemplary embodiments of the invention are shown. The inventive concept may, however, be embodied in many different forms and should not be construed as limited to the exemplary embodiments set forth herein. Rather, these embodiments are provided so that this disclosure will be thorough and complete, and will fully convey the scope of the invention to those of ordinary skilled in the art. The terminology used herein is for the purpose of describing particular embodiments only and is not intended to be limiting of the inventive concept. As used herein, the singular forms ‘a’, ‘an’, and ‘the’ are intended to include the plural forms as well, unless the context clearly indicates otherwise. It will be further understood that the terms “comprises’ and/or ‘comprising,’ when used in this specification, specify the presence of stated features, integers, operations, elements, and/or components, but do not preclude the presence or addition of one or more other features, integers, operations, elements, components, and/or groups thereof. It will be understood that, although the terms ‘first’, ‘second’, ‘third’, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

### First Embodiment

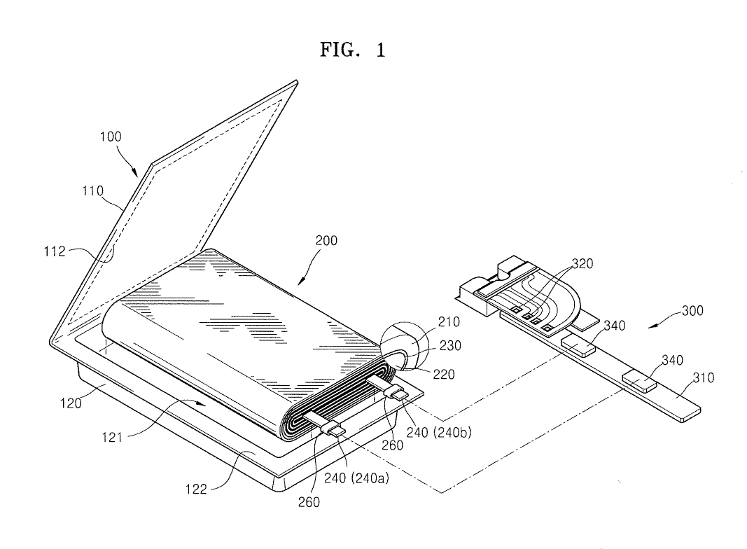

FIG. 1 is a schematic perspective view of an assembling structure of a battery pack according to an embodiment of the present invention. Referring to FIG. 1, the battery pack includes a battery cell including an electrode assembly 200 and a cover 100 accommodating the electrode assembly 200, and a protection circuit module (PCM) 300.

The cover 100 includes a lower cover 120 for accommodating the electrode assembly 200 and an upper cover 110 for sealing the electrode assembly 200. An accommodating portion 121 for accommodating the electrode assembly 200 is formed in the lower cover 120 using, for example, a press processing method. Edges of the lower cover 120 and the upper cover 110 may be integrally bonded to each other. To this end, a lower sealing portion 122 may be formed in the edge of the lower cover 120, and an upper sealing portion 112 may be formed in the edge of the upper cover 110. The upper sealing portion 112 and the lower sealing portion 122 may be bonded to each other using a thermal welding method.

The electrode assembly 200 may be manufactured by laminating a positive electrode plate 210 on which a positive slurry including a positive electrode active material is coated, a negative electrode plate 220 on which a negative slurry including a negative electrode active material is coated, and a separator 230 disposed between the positive electrode plate 210 and the negative electrode plate 220, forming a laminate, and coiling the laminate. The separator 230 is disposed between the positive electrode plate 210 and the negative electrode plate 220 to prevent an electrical short therebetween.

The positive electrode plate 210 may include a positive electrode active material layer in which the positive electrode slurry is coated on a positive electrode current collector formed of, for example, aluminium, and a positive electrode plain portion in which the positive electrode slurry is not coated on the positive electrode current collector. The positive electrode slurry includes the positive electrode active material. The positive electrode active material may use, for example, a lithium-containing transition metal oxide such as LiCoO₂, LiNiO₂, LiMnO₂, or LiMnO₄ or a lithium chalcogenide compound. Meanwhile, the positive electrode plain portion is bonded to a positive electrode tap 240a of a predetermined length. A part of the positive electrode tap 240a externally protrudes out from the cover.

The negative electrode plate 220 may include a negative electrode active material layer in which the negative electrode slurry is coated on a negative electrode current collector formed of, for example, nickel, and a negative electrode plain portion in which the negative electrode slurry is not coated on the negative electrode current collector. The negative electrode slurry includes the negative electrode active material. The negative electrode active material may use, for example, a carbon material such as crystalline carbon, amorphous carbon, carbon complex, or a carbon fiber, a lithium metal, or a lithium alloy. Meanwhile, the negative electrode plain portion is bonded to a negative electrode tap 240b of a predetermined length. A part of the negative electrode tap 240b externally protrudes out from the cover 100.

Meanwhile, the battery cell may be a polymer cell in which at least one of a positive electrode, a negative electrode, and an electrolyte thereof is formed of a polymer. In the polymer cell that uses a polymer electrolyte, the separator 230 may function as an ion conductivity medium, i.e., as the electrolyte, in addition to functioning to separate the electrodes. The polymer electrolyte may be a gel or solid polymer electrolyte. The polymer electrolyte may use, for example, PEO: poly(ethylene oxide), PAN: poly(acrylonitrile), PMMA: poly(methylmethacrylate), PDVF: poly(vinylidene fluoride), or the like. The gel or solid polymer electrolyte may secure reliability since the electrolyte is not externally exposed out of the cover 100. Meanwhile, if the positive electrode is formed of a polymer, an energy density of the battery cell may increase. The positive electrode may be a conductive polymer. The conductive polymer may use, for example, Polyaniline, Polyacetylene, Polythiophene, Poly(thienylene vinylene), Poly(p-phenylene vinylene), Polypyrrole, or the like.

A pair of electrode taps 240 are the positive electrode tap 240a and the negative electrode tap 240b and is electrically connected to the PCM 300. The electrode taps 240 may partially protrude from the cover 100 as shown in FIG. 1. In this case, in order to improve a seal between the cover 100 and the electrode taps 240, an adhesive tap tape 260 may be disposed on portions where the upper sealing portion 112 and the lower sealing portion 122 overlap and wrap around the positive electrode tap 240a and the negative electrode tap 240b.

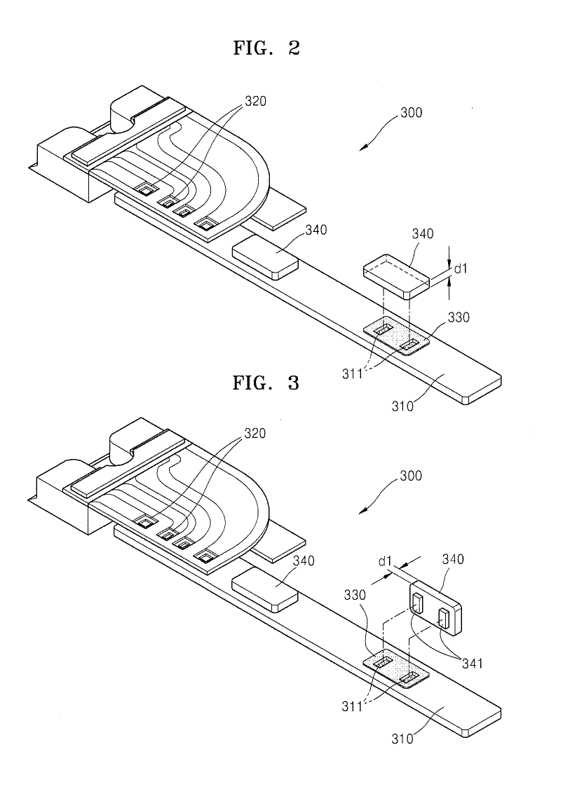

Although one pair of electrode taps 240 includes the positive electrode tap 240a and the negative electrode tap 240b in the present embodiment, the present invention is not limited thereto. For example, a plurality of pairs of electrode taps 240 may be formed. In this case, the PCM 300 includes a plurality of connection blocks 340 in numbers equal to the number of the positive electrode taps 240a and the negative electrode taps 240b of the plurality of pairs of electrode taps 240. The PCM 300 and the connection blocks 340 will now be described with reference to FIG. 2.

FIG. 2 is a schematic exploded perspective view of an assembling state of the PCM 300 and the connection blocks 340 of FIG. 1 according to an embodiment of the present invention.

Referring to FIG. 2, the PCM 300 includes a substrate 310 and a plurality of protection circuits. The protection circuits are for preventing a battery cell from overheating or exploding due to an excessive charge, discharge, or current of the battery cell and may be mounted in the substrate 310. The substrate 310 may be formed of an electrically insulating material. For example, the substrate 310 may be formed of an electrically insulation material that is flexible, such as PET: Poly Ethylene Terephthalate and PI: Polyimide. A load terminal 320 is electrically connected to an external load (not shown).

The connection blocks 340 are disposed on one side surface of the substrate 310. The connection bocks 340 are used to electrically connect the electrode taps 240 and the PCM 300, and are disposed on locations corresponding to the electrode taps 240. The connection blocks 340 may be formed of an electrically conductive material. For example, the connection blocks 340 may be formed of nickel in view of an (desired) electrical conductivity.

A process of fixing the connection blocks 340 to the substrate 310 will now be described below. A plurality of grooves 311 are formed on one side surface of the substrate 310 in order to expose a metal layer of the protection circuits mounted in the substrate 310. A welding material 330 is applied on an upper portion of the substrate 310 on which the metal layer is exposed. The connection blocks 340 are disposed on the welding material 330, and are sintered thereto. Thus, the connection blocks 340 are fixed to the substrate 310. The welding material 330 may use, for example, a soldering cream. Meanwhile, the connection blocks 340 may be electrically connected to the protection circuits mounted in the substrate 310 through the grooves 311.

The connection blocks 340 are fixed to one side surface of the substrate 310 as described above, and thus it is unnecessary to form an additional insertion hole in the substrate 310 in order to fix the connection blocks 340, which results in an increase in a space of the substrate 310 for mounting protection circuits or other devices therein. A utility of space increases, and thus a thin battery pack may be manufactured.

Thicknesses d1 of the connection blocks 340 may be from about 0.3 mm to about 1.2 mm. If the thicknesses d1 of the connection blocks 340 are under 0.3 mm, the PCM 300 may be damaged in fixing the connection blocks 340 to the substrate 310. For example, the protection circuits may be damaged in applying the soldering cream on the substrate 310 and sintering the connection blocks 340 thereto. Meanwhile, if the thicknesses d1 of the connection blocks 340 exceeds 0.3 mm, the connection blocks 340 may not be freely assemble to other devices. For example, if the battery pack is installed in a small device such as a mobile phone, the thicknesses d1 of the connection blocks 340 may not exceed the 1.2 mm in view of the sizes of the small device and the battery pack.

Meanwhile, the connection blocks 340 may be partially buried in the PCM 300. In the present embodiment with reference to FIG. 2, when the welding material 300 is applied and sintered, the connection blocks 340 are partially melted and filled into the grooves 311, and thus the connection blocks 340 may be partially buried in the PCM 300.

According to another embodiment of the present invention, a plurality of burying portions 341 that are to be buried in the PCM 300 may be additionally formed in one side surface of the connection blocks 340. Referring to FIG. 3, the burying portions 341 may be formed in locations corresponding to the grooves 311 in one side surface of the connection blocks 340 and may be buried in the PCM 300. In the present embodiment, the connection blocks 340 and the PCM 300 may be coupled to each other by applying the welding material 330 on the substrate 300 and sintering the connection blocks 340 thereto.

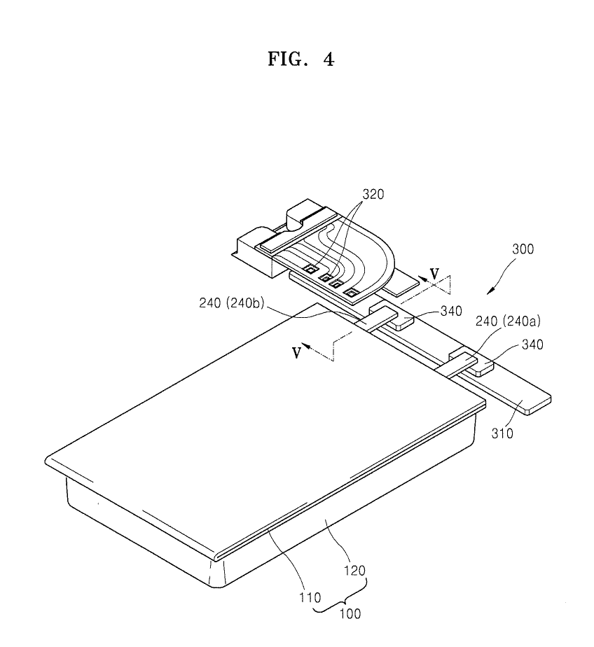

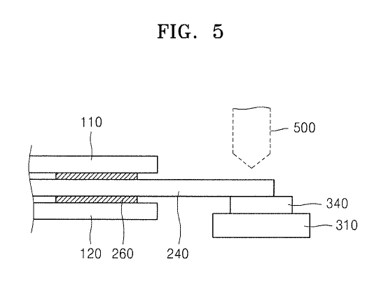

FIG. 4 is a perspective view of the battery pack assembled with the PCM 300 of FIG. 1. FIG. 5 is a cross-sectional view of the battery pack of FIG. 4 taken along a line V-V.

The electrode taps 240 are electrically connected to the connection blocks 340. For example, the electrode taps 240 may be electrically connected to the connection blocks 340 by contacting one side surface of the electrode taps 240 and the connection blocks 340. In this regard, the electrode taps 240 and the connection blocks 340 may be welded to each other in order to reliably maintain a contact state between the electrode taps 240 and the connection blocks 340. A laser welding method may be used in view of the thicknesses of the electrode taps 240 and the connection blocks 340. A welding pole 500 is used to perform a welding operation and is a laser radiator.

The connection blocks 340 are disposed on the substrate 310, and the electrode taps 240 are electrically connected to the PCM 300 by welding the connection blocks 340 and the electrode taps 240 to each other. Thus, heat or an impurity generated during the welding operation is rarely introduced into the PCM 300, thereby facilitating the welding operation and reducing defects generated in the battery pack due to the welding operation.

### Second Embodiment

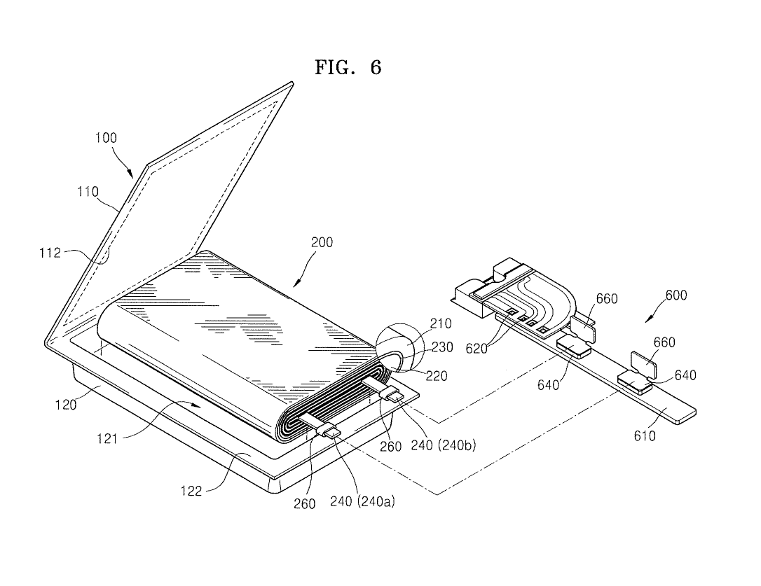

FIG. 6 is a schematic perspective view of an assembling structure of a battery pack according to another embodiment of the present invention. Referring to FIG. 6, the battery pack includes the cover 100, an electrode assembly 200, and a PCM 600. The present embodiment is the same as the first embodiment except that the battery pack further includes connection terminals 660 used to electrically connect the electrode taps 240 and the PCM 600, in addition to a plurality of connection blocks 640. The difference between the first and second embodiments will now be described for descriptive convenience.

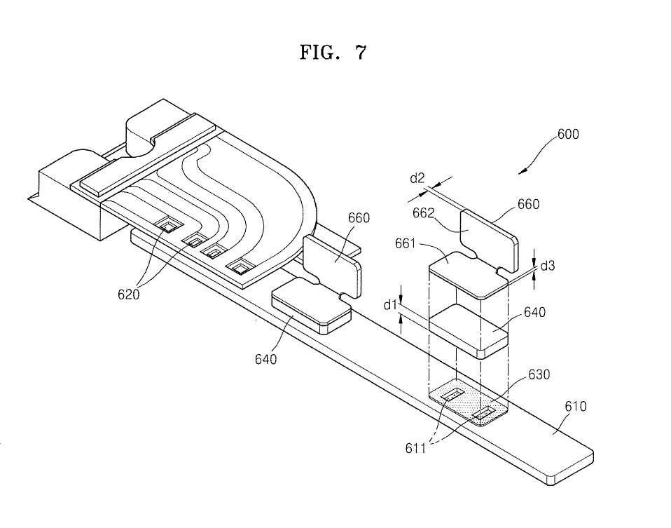

FIG. 7 is a schematic exploded perspective view of an assembling state of the PCM 600, the connection blocks 640, and the connection terminals 660 according to an embodiment of the present invention. The connection terminals 660 include a first terminal portion 661 that has one side surface contacting the connection blocks 640 and a second terminal portion 662 that is bent to form a predetermined angle with the first terminal portion 661. For example, the second terminal portion 662 may be bent perpendicular to the first terminal portion 661 and protrude in one side direction of a substrate 610.

One side surface of the first terminal portion 661 contacts the connection blocks 640. The first terminal portion 661 and the connection blocks 640 may be welded or adhered to each other in order to reliably maintain contact between the first terminal portion 661 and the connection blocks 640. For example, the first terminal portion 661 and the connection blocks 640 may be coupled to each other by applying a soldering cream to the substrate 610 as the welding material 330 and sintering the connection blocks 640 thereto. Alternatively, a welding method such as resistance welding and laser welding or a double-sided tape may be used to couple the first terminal portion 661 and the connection blocks 640 to each other.

A thickness d3 of the first terminal portion 661 and a thickness d2 of the second terminal portion 662 may be different from each other. For example, since the connection blocks 640 are disposed in a lower portion of the first terminal portion 661, the thickness d3 of the first terminal portion 661 may be smaller than the thickness d2 of the second terminal portion 662. As an example, the thickness d3 of the first terminal portion 661 may be determined in such a way that the first terminal portion 661 and the connection blocks 640 are easily coupled to each other, for example, in such a way that the first terminal portion 661 and the connection blocks 640 are easily coupled to each other through welding.

Another side surface of the first terminal portion 661 contacts the electrode taps 240. The connection terminals 660 and the connection blocks 640 are used to electrically connect the electrode taps 240 and the PCM 600 to each other, and thus are manufactured using an electrically conductive material. For example, at least one of the connection terminals 660 and the connection blocks 640 may be manufactured using a nickel material in view of the (a desired) electrical conductivity.

Although the connection terminals 660 and the connection blocks 640 are coupled to each other in the present embodiment, the present invention is not limited thereto. For example, the connection terminals 660 and the connection block 640 may be integrally manufactured as a single element.

Meanwhile, in the present embodiment, the connection blocks 640 may be electrically connected to protection circuits through grooves 611 formed in the substrate 610. The connection blocks 640 may be partially buried in the PCM 600 as described above.

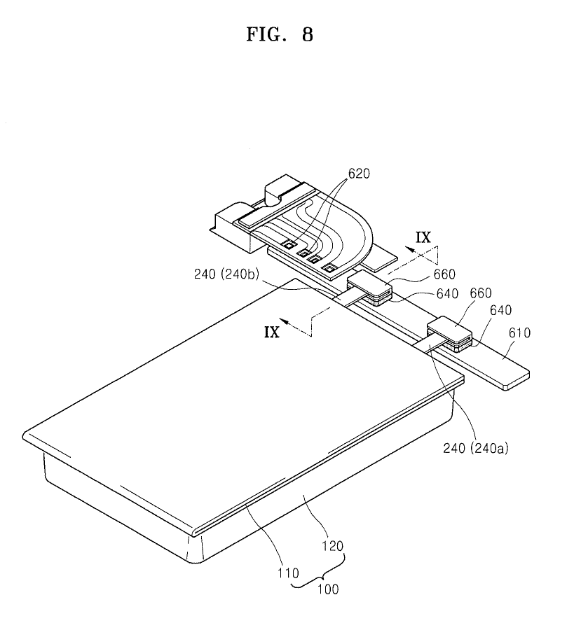

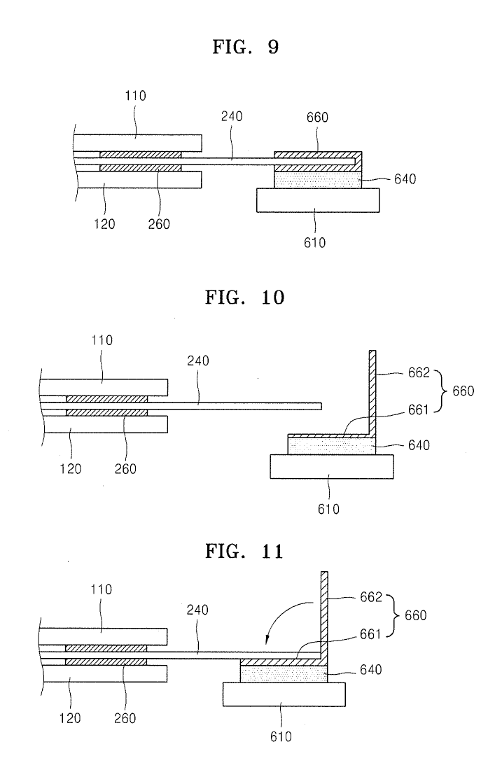

FIG. 8 is a perspective view of the battery pack assembled with the PCM 600. FIG. 9 is a cross-sectional view of the battery pack of FIG. 8 taken along a line IX-IX.

Referring to FIG. 8, the electrode taps 240 are electrically connected to the PCM 600 using the connection terminals 660 and the connection blocks 640. As shown, the electrode taps 240 may be disposed between the first terminal portion 661 and the second terminal portion 662. That is, if one side surface of the electrode taps 240 contacts the first terminal portion 661, another side surface of the electrode taps 240 is to contact the second terminal portion 662 by bending the electrode taps 240.

The electrode taps 240 are disposed between the first terminal portion 661 and the second terminal portion 662 by bending the second terminal portion 662, thereby securing an electrical connection between the electrode taps 240 and the PCM 600, and reducing generation of a defect when manufacturing the battery pack. The electrode taps 240 may be welded to the connection terminal 660.

FIGS. 10 through 12 are cross-sectional views for explaining a process of welding the electrode taps 240 and the connection terminals 660.

Referring to FIG. 10, the battery cell, the connection blocks 640, and the connection terminals 660 are disposed in the PCM 600. The electrode taps 240 partially protrude out of the battery cell. The connection blocks 640 and the connection terminals 660 are sequentially stacked on an upper portion of the substrate 610. The connection terminals 660 include the first terminal portion 661 that contacts the connection blocks 640 and the second terminal portion 662 that is perpendicular to the first terminal portion 661. One side surface of the first terminal portion 661 is coupled to the connection blocks 640. The connection blocks 640 are fixed to the substrate 610 using a welding material 630 as shown in FIG. 7.

Referring to FIG. 11, the electrode taps 240 contact the first terminal portion 661, and the second terminal portion 662 is bent onto the electrode taps 240 so that the electrode taps 240 are disposed between the first terminal portion 661 and the second terminal portion 662. That is, the second terminal portion 662 is bent to wrap around the electrode taps 240. In this regard, the second terminal portion 662 is bent perpendicular to the first terminal portion 661 so that the second terminal portion 662 may wrap around the electrode taps 240 in the shape of a “ [symbol] ”.

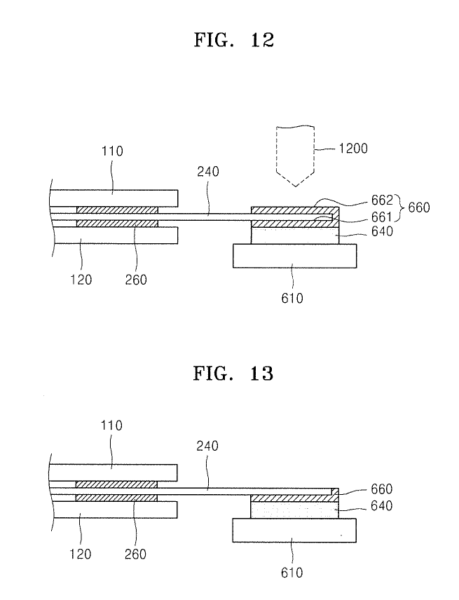

Referring to FIG. 12, the connection terminals 660 and the electrode taps 240 may be fixed to each other by performing a welding operation on the bent second terminal portion 662. A laser welding method may be used in view of the thicknesses of the connection terminal 660 and the electrode taps 240. A welding pole 1200 is used to perform the welding operation and is a laser radiator.

The electrode taps 240 are disposed between the first terminal portion 661 and the second terminal portion 662 and wrapped by the connection terminals 660, thereby facilitating the welding operation and reliably maintaining the electrical connection between the electrode taps 240 and the PCM 600.

FIG. 13 is a cross-sectional view of the battery pack of FIG. 9 according to another embodiment of the present invention. Referring to FIG. 13, the second terminal portion 662 does not cover another side surface of the electrode taps 240 and the connection terminals 660 only contact the side surface thereof. A lower surface and a side surface of the electrode taps 240 may contact the connection terminals 660 by reducing the height of the second terminal portion 662. In this case, the electrode taps 240 and the connection terminals 660 may be fixed to each other by irradiating laser on an upper surface of the electrode taps 240. Meanwhile, the second terminal portion 662 and the first terminal portion 661 are perpendicular to each other so that the contact surface between the electrode taps 240 and the connection terminals 660 may be increased, thereby increasing the electrical connection between the electrode taps 240 and the PCM 600.

It should be understood that the exemplary embodiments described therein should be considered in a descriptive sense only and not for purposes of limitation. Descriptions of features or aspects within each embodiment should typically be considered as available for other similar features or aspects in other embodiments.

[Explanation of Numerals]

| | |
|---|---|
| 100: cover | 110: upper cover |
| 112: upper sealing portion | 120: lower cover |
| 121: accommodation portion | 122: lower sealing portion |
| 200: electrode assembly | 210: positive electrode plate |
| 220: negative electrode plate | 230: separator |
| 240: electrode tap | 240a: positive electrode tap |
| 240b: negative electrode tap | 260: adhesive tap tape |
| 300, 600: protection circuit module | 310, 610: substrate |
| 311, 611: groove | 320, 620: load terminal |
| 330, 630: welding material | 340, 640: connection block |
| 341: burying portion | 500, 1200: laser radiator |
| 660: connection terminal | 661: first terminal portion |
| 662: second terminal portion | |

What is claimed is:

1. A battery pack comprising:
a battery cell;
an electrode tap protruding from the battery cell;
a protection circuit module comprising a protection circuit for the battery cell; and
a connection block on the protection circuit module electrically coupling the electrode tap to the protection circuit module.

2. The battery pack of claim 1, further comprising a connection terminal contacting the connection block and the electrode tap to electrically couple the electrode tap to the connection block.

3. The battery pack of claim 2, wherein the connection terminal and the connection block are integral as a single unit.

4. The battery pack of claim 2, wherein the connection terminal comprises:
a first terminal portion contacting the connection block; and
a second terminal portion coupled to the first terminal portion and contacting the electrode tap.

5. The battery pack of claim 4, wherein the first terminal portion is coupled to a first side of the electrode tap and the second terminal portion is coupled to a second side of the electrode tap substantially opposite to the first side.

6. The battery pack of claim 4, wherein at least one of the connection block and the connection terminal comprises nickel or a nickel alloy.

7. The battery pack of claim 4, wherein the first terminal portion is substantially perpendicular to the second terminal portion.

8. The battery pack of claim 1, wherein the electrode tap is coupled to the connection block by a weld.

9. The battery pack of claim 1, wherein a thickness of the connection block is between about 0.3 mm to about 1.2 mm.

10. The battery pack of claim 1, wherein the connection block is partially embedded into the protection circuit module.

11. The battery pack of claim 1, wherein the connection block has a protrusion and the protection circuit module has a groove generally corresponding to and accommodating the protrusion.

12. The battery pack of claim 1, wherein a coupling material is located between the protection circuit module and the connection block.

13. The battery pack of claim 12, wherein the coupling material is soldering cream.

14. The battery pack of claim 1, wherein the battery cell is a polymer cell.
